(19) United States
(12) Patent Application Publication
(10) Pub. No.: US 2017/0154763 A1
(43) Pub. Date: Jun. 1, 2017

(54) MASS SPECTROMETRY SYSTEM AND METHOD FOR CONTAMINANT IDENTIFICATION IN SEMICONDUCTOR FABRICATION

(71) Applicant: GLOBALFOUNDRIES INC., Grand Cayman (KY)

(72) Inventors: Qin Yuan, Poughquag, NY (US); Mark S. Chace, Beacon, NY (US); Steven E. Molis, Patterson, NY (US); Janine L. Protzman, Poughkeepsie, NY (US)

(21) Appl. No.: 14/954,053

(22) Filed: Nov. 30, 2015

(51) Int. Cl. H01J 49/04; H01J 49/00; H01J 49/24; H01J 49/16

(52) U.S. Cl. CPC H01J 49/0463; H01J 49/164; H01J 49/0031; H01J 49/24; H01J 49/0404

(57) ABSTRACT

A mass spectrometer system includes a chamber configured to receive a sample; a gas source coupled to the chamber for delivering a gas across the sample; and a desorption energy source configured to desorb a contaminant from a test area of the sample. The system may also include a mass spectrometer including a vacuum source, an ion source, a mass analyzer and a detector, and a capillary transfer line operatively coupled to the chamber and the mass spectrometer and configured to deliver desorbed volatiles of the contaminant from the test area to the mass spectrometer, the capillary transfer line having an intake proximal the test area. A method of identifying a contaminant is also disclosed.

### BACKGROUND

Technical Field

The present disclosure relates to mass spectrometry, and more specifically, to systems and methods for contaminant identification in semiconductor fabrication using mass spectrometry.

Related Art

In semiconductor fabrication, contamination of wafers during manufacture can prevent production of usable integrated circuit chips. Hence, all semiconductor fabrication is performed in a clean room environment. Despite the use of clean room fabrication, contamination can still occur and processes to identify such contamination must be employed because even trace levels of a contaminant can create production problems and negatively impact semiconductor device performance.

Identification of small spot contaminants on product wafers presents a challenging chemical analysis because traditional analysis techniques often do not have sufficient sensitivity to detect and identify such small, trace levels of contaminants. Conventionally, mass spectrometry is one approach used to identify contaminants. One form of mass spectrometer uses a laser to desorb and ionize a test area from a sample. This form of mass spectrometer is referred to generically as laser desorption mass spectrometer (LDMS) and can be obtained in a number of forms such as: laser microprobe mass analyzer (LAMMA), laser ionization mass spectrometer (LIMS), or laser ionization mass analyzer (LIMA). In LDMS, as shown in a LAMMA example in FIG. 1, a sample 10 such as a semiconductor wafer, is placed in a chamber 12 and materials on a surface thereof are ionized using, for example, a laser 14. The ions generated from the sample are used to identify the contaminants.

One challenge of the above-listed devices is that they require that the sample analyzed be under an ultra-high vacuum environment in chamber 12. That is, an ultra-high vacuum environment is present across an entirety of chamber 12 (source of vacuum not shown). Additionally, for all of these existing techniques, the short duration of the ion burst upon laser pulse precludes the use of traditional scanning type mass spectrometers, instead requiring a time-of-flight mass spectrometry (TOFMS) approach. In TOFMS, as also shown in FIG. 1, in order to move each ion to a mass spectrometer 16, each ion generated from a sample is accelerated by a predetermined, known electric field created by an electric field generator 18 (e.g., an electromagnet). Each ion takes on the same charge, and so the speed of the ion depends on the mass-to-charge ratio of the ion. An ion's mass-to-charge ratio is identified by an amount of time the ion takes to travel a distance through a time-of-flight (TOF) passage 20 to mass spectrometer 16. The travel duration (and other known operational parameters) can be used to determine the mass of the ion (heavier ions travel slower), and the mass of the ion can be used to identify chemical composition and, in the case of organic molecules, structural information.

The above-described TOFMS systems and methods also limit the type of sample which can be tested. For example, with LAMMA analysis, the sample must be small and thin. Consequently, ionization of unintended areas next to a test area (referred to as matrix effects) can be problematic because ionization of too much material results in excessive plasma whose time spread and ion energy distribution entering the mass spectrometer can result in undesired peak deformations that prevent contaminant analysis.

### SUMMARY

A first aspect of the disclosure is directed to a mass spectrometer system comprising: a chamber configured to receive a sample; a gas source coupled to the chamber for delivering a gas across the sample; a desorption energy source configured to desorb a contaminant from a test area of the sample; a mass spectrometer including a vacuum source, an ion source, a mass analyzer and a detector; and a capillary transfer line operatively coupled to the chamber and the mass spectrometer and configured to deliver desorbed volatiles of the contaminant from the test area to the mass spectrometer, the capillary transfer line having an intake proximal the test area.

A second aspect of the disclosure includes a mass spectrometer system comprising: a chamber configured to receive a semiconductor wafer sample; a gas source coupled to the chamber for delivering a gas across the semiconductor wafer sample; a laser configured to desorb a contaminant from a test area of the sample; a mass spectrometer including a vacuum source, an ion source, a mass analyzer and a detector; and a capillary transfer line operatively coupled to the chamber and the mass spectrometer and configured to deliver desorbed volatiles of the contaminant from the test area to the mass spectrometer, the capillary transfer line having an intake proximal the test area.

A third aspect of the disclosure related to a method of identifying a contaminant on a semiconductor wafer, the method comprising: delivering a gas across a semiconductor wafer sample in a chamber from a gas source coupled to the chamber; desorbing volatiles from a test area of the semiconductor wafer sample using a desorption energy source; delivering desorbed volatiles from the test area to a mass spectrometer using a capillary transfer line operatively coupled to the chamber and the mass spectrometer, an intake of the capillary transfer line positioned proximal the test area; and identifying the contaminant in the test area by analyzing the desorbed volatiles using the mass spectrometer.

The foregoing and other features of the disclosure will be apparent from the following more particular description of embodiments of the disclosure.

### BRIEF DESCRIPTION OF THE DRAWINGS

The embodiments of this disclosure will be described in detail, with reference to the following figures, wherein like designations denote like elements, and wherein:

FIG. 1 shows a schematic, cross-sectional view of a conventional laser desorption mass spectrometer (LDMS) system.

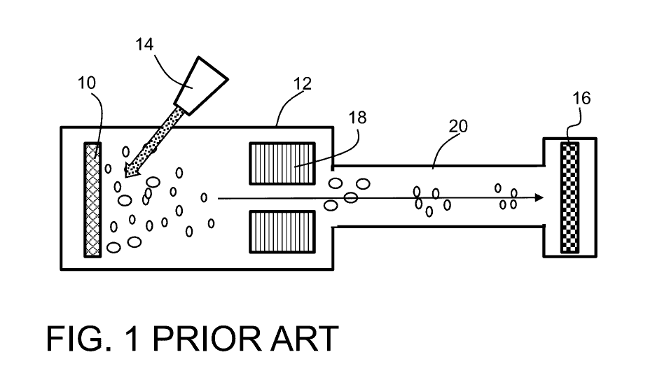

FIG. 2 shows a schematic, cross-sectional view of a mass spectrometer system according to embodiments of the disclosure.

### DETAILED DESCRIPTION

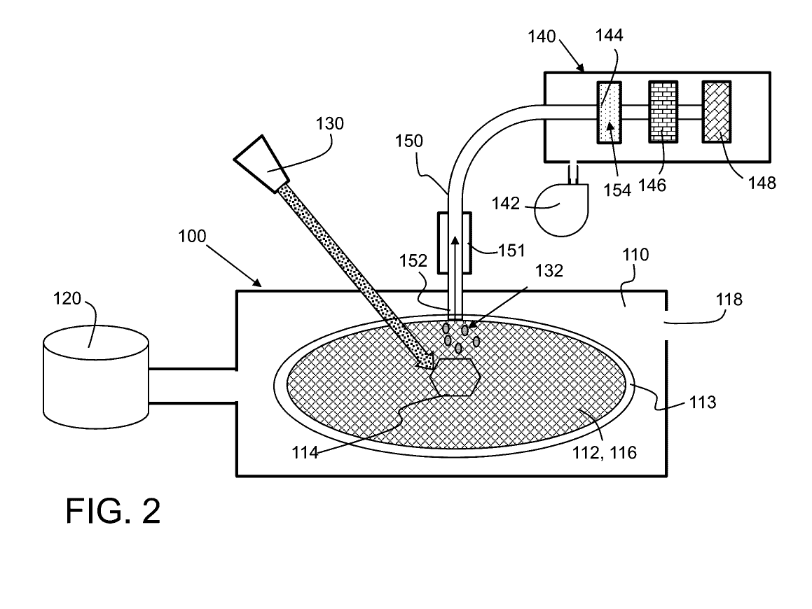

Referring to FIG. 2, a schematic, cross-sectional view of a mass spectrometer system 100 according to embodiments of the disclosure is shown.

System 100 may include a chamber 110 configured to receive a sample 112 to be analyzed. Sample 112 may be placed on, for example, a 3-axis stage 113 to allow the alignment of test area 114 with a desorption energy source 130 and a capillary transfer line intake 152. Sample 112 may include any sample capable of having volatiles desorbed from a test area 114 thereof. In the example shown, sample 112 includes a semiconductor wafer sample 116, which may include an entire semiconductor wafer or a part thereof. Semiconductor wafer sample 116 may have been exposed to any level of semiconductor fabrication. Chamber 110 may include any chamber with an outlet 118 to maintain a positive purging gas flow, such as those typically employed for mass spectrometry and/or semiconductor wafer processing. However, for reasons that will be described herein, chamber 110 can be at atmospheric pressure—no vacuum pressure is required.

System 100 may also include a gas source 120 coupled to chamber 110 for delivering a gas across sample 112 and purging air out of the system. Gas source 120 can be any now known or later developed source of gas, e.g., a tank, flow from another source, etc. Gas source 120 may also include any desired form of regulator or controls (not shown) to provide a desired flow of gas, e.g. approximately 10 milliliters/minute (ml/min) to approximately 100 ml/min. In embodiments of the disclosure, the gas may include, but is not limited to: helium, nitrogen or argon.

System 100 also may include a desorption energy source 130 configured to desorb a contaminant from test area 114 of sample 112. Desorption energy source 130 may include any form of energy source capable of desorbing volatiles 132 from test area 114, e.g., laser, electron beam, thermal transmitter, ultraviolet (UV) light, etc. In the example shown, desorption energy source 130 includes a laser. Test area 114 may have any shape or size desired based on desorption energy source 130 provided. The contaminants (also referred to as volatiles) desorbed (and later identified) can take a variety of forms. In a semiconductor fabrication setting, for example, contaminants/volatiles 132 may include but are not limited to: hydrocarbons, organics, siloxane, etc.

A mass spectrometer 140 of system 100 includes a vacuum source 142, an ion source 144, a mass analyzer 146 and a detector 148. In any event, vacuum source 142 includes conventional mass spectrometer vacuum source, e.g., a turbo pump backed up by a roughing pump, etc., that pulls volatiles 132 through capillary transfer line 150 into mass spectrometer ion source 144 but is insufficient to create a vacuum environment in chamber 110. Chamber 110 is at atmospheric pressure. In ion source 144, electrons bombard volatiles 132 to convert them to ions 154. Mass analyzer 146, e.g., of a quadrupole or ion trap form, selects ions 154 based on their mass to charge ratios. Detector 148 may take the form of any variety of conventional detectors such as electron multiplier, etc. Such systems are available in a variety of models from a number of manufacturers such as but not limited to: Thermo Electron or Agilent. In contrast to conventional systems, system 100 includes a capillary transfer line 150 which is operatively coupled to chamber 110 and mass spectrometer 140. Capillary transfer line 150 is configured to deliver desorbed volatiles 132 of the contaminant from test area 114 to mass spectrometer 140 under the vacuum provided by vacuum source 142. Capillary transfer line 150 may include a temperature controller 151 to maintain a temperature thereof and/or therein between approximately 20° C. and approximately 300° C. to prevent condensation of volatiles 132 inside of capillary transfer line 150. Temperature controller 151 can include any now known or later developed temperature control system for a transfer line, e.g., conduction heater, thermostat control, etc. In this setting, capillary transfer line 150 includes an intake 152 proximal test area 114 such that desorbed volatiles 132 of the contaminant are readily delivered to mass spectrometer 140. In other words, rather than an ultra-high vacuum being created entirely within the chamber, a highly concentrated smaller vacuum is created at intake 152 impacting mostly desorbed volatiles 132. As used herein, “proximal” may indicate a distance of approximately 0.1 millimeters to approximately 10 millimeters from test area 114. Capillary transfer line 150 may have an internal diameter in a range of approximately 0.05 to approximately 0.5 millimeters. Capillary transfer line 150 can have any length (e.g., approximately 10 centimeters to approximately 1 meter in length depending on design) and/or curvature necessary for the particular application. As used herein, “approximately” indicates +/−10% of the upper and/or lower range limit regardless of whether the term is used on one or both values of the range. Since chamber 110 is at atmospheric pressure, system 100 provides a higher efficiency of volatiles transfer from test area 114 to mass spectrometer 140. More specifically, the lack of an ultra-high vacuum prevents the loss or dilution of contaminants/volatiles 132 into the evacuated environment before detection and identification, thus facilitating capture of a much higher percentage of contaminants/volatiles with resulting enhanced sensitivity. Further, capillary transfer line 150 in close proximity to test area 114 allows nearly all contaminants/volatiles 132 generated to be immediately drawn into capillary transfer line 150 with immediate introduction to mass spectrometer 140 because capillary transfer line 150 is attached directly to the mass spectrometer 140.

In operation according to a method of identifying a contaminant on a semiconductor wafer 116, semiconductor wafer sample 116 is placed in chamber 110. A gas (not shown), e.g., helium, is delivered across semiconductor wafer sample 116 from gas source 120, which is operatively coupled to chamber 110. Volatiles 132 are desorbed from test area 114 of semiconductor wafer sample 116 using desorption energy source 130, e.g., a laser. Intake 152 of capillary transfer line 150 is positioned to be operatively coupled to chamber 110 and mass spectrometer 140 proximal test area 114. Capillary transfer line 150 delivers desorbed volatiles 132 from test area 114 to mass spectrometer 140, i.e., ion source 144. The gas removes air and moisture from chamber 110 to protect mass spectrometer 140. A temperature of capillary transfer line 150 may be maintained between approximately 20° C. and approximately 300° C. One or more contaminants in test area 114 can be detected and identified by analyzing desorbed volatiles 132 using mass spectrometer 140 in a conventional manner. It is emphasized that the steps as presented herein need not be in the exact order presented, e.g., when the gas source and/or laser operation begins and when the positioning of the capillary transfer line occurs can be revised.

System 100 employing capillary transfer line 150 presents a number of advantages compared to conventional time-of-flight and other existing LDMS systems. For example, as noted herein, system 100 provides enhanced sensitivity of detection and identification of desorbed contaminants/volatiles for small-spot mass spectrometry analysis. In addition, since the capillary transfer line creates highly precise, localized vacuum to capture all contaminants/volatiles as they are generated from the desorption event, system 100 is not impacted by matrix effects. This approach also significantly enhances sensitivity of detection and identification of contaminants/volatiles from the desorption site while minimizing “background” from the unexposed area of the sample. System 100 also allows for use of a conventional mass spectrometer rather than existing techniques that require time-of-flight mass spectrometers. Consequently, system 100 is less complex and relatively simple to operate compared to existing systems.

The method as described above is used in the testing of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A mass spectrometer system comprising:
a chamber configured to receive a sample, the chamber at atmospheric pressure;
a gas source coupled to the chamber for delivering a gas across the sample;
a desorption energy source configured to desorb a volatile contaminant from a test area of the sample;
a mass spectrometer including a vacuum source, an ion source, a mass analyzer and a detector; and
a capillary transfer line operatively coupled to the chamber and the mass spectrometer and configured to deliver the volatile contaminant from the test area to the mass spectrometer, the capillary transfer line having an intake proximal the test area
wherein the vacuum source pulls the volatile contaminant from the chamber through the capillary transfer line to the ion source.

2. The mass spectrometer system of claim 1, wherein the mass spectrometer includes one of a quadrupole type mass spectrometer and an ion trap type mass spectrometer.

3. The mass spectrometer system of claim 1, wherein the gas is selected from the group consisting of: helium, nitrogen and argon.

4. The mass spectrometer system of claim 1, wherein the desorption energy source includes a laser.

5. The mass spectrometer system of claim 1, wherein the capillary transfer line has an internal diameter in a range of approximately 0.05 millimeter to approximately 0.5 millimeter.

6. The mass spectrometer system of claim 1, wherein the sample includes a semiconductor wafer.

7. The mass spectrometer system of claim 1, further comprising a temperature controller to maintain a temperature of the capillary transfer line between approximately 20° C. and approximately 300° C.

8. A mass spectrometer system comprising:
a chamber configured to receive a semiconductor wafer sample;
a gas source coupled to the chamber for delivering a gas across the semiconductor wafer sample;
a laser configured to desorb a volatile contaminant from a test area of the sample;
a mass spectrometer including a vacuum source, an ion source, a mass analyzer and a detector; and
a capillary transfer line operatively coupled to the chamber and the mass spectrometer and configured to deliver of the volatile contaminant from the test area to the mass spectrometer, the capillary transfer line having an intake proximal the test area
wherein the vacuum source pulls the volatile contaminant from the chamber through the capillary transfer line to the ion source.

9. The mass spectrometer system of claim 8, wherein the mass spectrometer includes one of a quadrupole type mass spectrometer and an ion trap type mass spectrometer.

10. The mass spectrometer system of claim 8, wherein the gas is selected from the group consisting of: helium, nitrogen and argon.

11. The mass spectrometer system of claim 8, wherein the capillary transfer line has an internal diameter in a range of approximately 0.05 millimeter to approximately 0.5 millimeter.

12. The mass spectrometer system of claim 8, further comprising a temperature controller to maintain a temperature of the capillary transfer line between approximately 20° C. and approximately 300° C.

13. A method of identifying a contaminant on a semiconductor wafer, the method comprising:
delivering a gas across a semiconductor wafer sample in a chamber from a gas source coupled to the chamber;
desorbing volatiles from a test area of the semiconductor wafer sample using a desorption energy source;
delivering desorbed volatiles using a vacuum that pulls desorbed volatiles from the test area to a mass spectrometer ion source using a capillary transfer line operatively coupled to the chamber and the mass spectrometer, an intake of the capillary transfer line positioned proximal the test area; and
identifying the contaminant in the test area by analyzing the desorbed volatiles using the mass spectrometer.

14. The method of claim 13, wherein the mass spectrometer includes one of a quadrupole type mass spectrometer and an ion trap type mass spectrometer.

15. The method of claim 13, wherein the gas is selected from the group consisting of: helium, nitrogen and argon.

16. The method of claim 13, wherein the desorption energy source includes a laser.

17. The method of claim 13, wherein the capillary transfer line has an internal diameter in a range of approximately 0.05 millimeter to approximately 0.5 millimeter.

18. The method of claim 13, further comprising maintaining a temperature of the capillary transfer line between approximately 20° C. and approximately 300° C.
